(19) United States
(12) Patent Application Publication
(10) Pub. No.: US 2010/0291889 A1
(43) Pub. Date: Nov. 18, 2010

(54) RADIO TUNER USER INTERFACE

(75) Inventors: Morgan Colmer, Cambridge (GB); Christoper Whitehouse, Suffolk (GB); Martin Bastin, Bedfordshire (GB)

Correspondence Address: STOEL RIVES LLP - PDX, 900 SW FIFTH AVENUE, SUITE 2600, PORTLAND, OR, 97204-1268, US

(73) Assignee: GS IP Limited Liability Company, Wilmington, DE (US)

(21) Appl. No.: 12/160,775

(22) PCT Filed: May 22, 2006
(86) PCT No.: PCT/GB2006/001873

§ 371 Date: Mar. 9, 2009

(51) Int. Cl. H04B 1/18

(52) U.S. Cl. 455/179.1

(57) ABSTRACT

A radio comprising a receiver for receiving signals comprising a plurality of signal components of different carrier frequencies and a tuner for selecting a signal component of a particular carrier frequency from the plurality of received signal components, the radio having a user interface comprising a user input component and the radio being configured to cause the tuner to operate in a first tuning mode when the user input component is activated for less than a first period of time, operate in a second tuning mode when the user input component is activated for longer than the first period of time and less than a second period of time and operate in a third tuning mode when the user input component is activated for at least the second period of time.

### CROSS REFERENCE TO RELATED APPLICATION

This application is a 35 U.S.C. §371 application based on PCT Patent Application No. PCT/GB2006/001873, filed May 22, 2006, entitled “RADIO TUNER USER INTERFACE,” which is incorporated herein by reference in its entirety.

### BACKGROUND

Radios enable users to listen to audio signals that are broadcast by modulating high frequency carrier waves. Each radio station uses a carrier wave of a particular frequency. Users can therefore select a particular radio station to listen to by “tuning” a radio to the frequency of the carrier wave used by that station. This process is typically achieved by altering the frequency response of a selective filter in the radio, which attenuates signals that do not have the desired carrier frequency. The selected signal is then demodulated and fed to a loudspeaker.

### SUMMARY OF THE DISCLOSURE

Some radios can be tuned to a particular frequency by using a dial. The user turns the dial to move through the available frequency range. Typically, turning the dial clockwise increases the selected frequency while turning the dial counterclockwise decreases the selected frequency. More modern radios tend to use buttons or keys e.g., one to increase another to decrease the selected frequency. However, a manual arrangement such as this is inconvenient when the user wants to switch quickly between different radio stations. For example, the user might want to switch stations when adverts are broadcast on the station they are listening to, or in order to avoid a song they dislike or an annoying radio presenter. In such situations, the user often wants to switch between a number of different stations quickly and accurately, to check what is being broadcast by each station. The user may also want to return to the original station after a short period of time, for example, because an advert break will have finished. Manually tuning the radio can be a slow process, particularly when the user might want to change from a station broadcasting at the bottom end of the frequency range to a station broadcasting at the top end or vice versa. It may also be inaccurate and the user may have to make small frequency adjustments around the broadcasting frequency of the desired station before good quality reception of that station is achieved.

This problem has been solved by allowing the user to designate frequencies of stations that they listen to often. For example, the radio may be provided with a number of buttons that the user can assign to particular stations. If the user wants to listen to one of those stations, he presses the designated button and the radio will tune to the carrier frequency of that station. Typically, the user assigns a button to a particular station by tuning the radio to the appropriate frequency and then pressing that button for a predetermined length of time.

However, the user might also want to listen to different radio stations from the designated stations. For example, if the user is traveling, he might want to listen to a radio station local to his current location in order to receive local traffic updates. Such a local station would not be a designated station and would therefore not have an associated button. The user could adjust the radio frequency manually. However, this process can be slow as discussed above. Moreover, manually searching for a radio station takes longer when the user does not know what carrier frequency the station uses. Manually searching the available frequency range can also be inconvenient, as the user may be involved in another task at the time. Indeed, the case where the user is driving, manually searching for a radio station may actually be dangerous as it distracts the user's attention from the road.

As a solution to this problem, some radios provide a function in which the radio automatically searches through the range of radio frequencies and stops searching when it receives a signal of a predetermined quality. Therefore, having activated this function, the user is free to concentrate on other tasks. If the radio tunes to a station the user does not want to listen to, the user can restart the searching process from the frequency of that station. For example, by re-pressing a button that activates the automatic searching function.

On some occasions however, the automatic searching process does not identify the required station. For example, even if the station that the user wants to listen to is being received with insufficient quality for the searching process to select that station, the quality might nevertheless be acceptable to the user. Similarly, reception of the required station might be only temporarily of poor quality e.g., where the user is driving through a valley or tunnel. Also, an automatic search function is unsuitable for making slight adjustments around a designated frequency. Therefore, a radio should still provide a way for a user to change the frequency manually.

With the number of different tuning functions that a radio can provide to a user, there is a risk that the number of buttons or switches can become unwieldy. For example, in car radios the number of buttons should be kept to a minimum firstly, to minimize the size of the radio and secondly, so that the user can maintain his concentration on driving without having to work out which button to press to change the radio station.

According to one embodiment of the disclosure, there is provided a radio comprising a receiver configured to receive signals, wherein the signals comprise a plurality of signal components of different carrier frequencies, and a tuner configured to select a signal component of a particular carrier frequency from the plurality of received signal components, the radio having a user interface comprising a user input component (e.g., a user input component, such as a selector or button) and the radio being configured to cause the tuner to operate in a first tuning mode when the user input component is activated for less than a first period of time, operate in a second tuning mode when the user input component is activated for longer than the first period of time and less than a second period of time, and operate in a third tuning mode when the user input component is activated for at least the second period of time.

In an embodiment, the radio further comprises a tuning mode selector configured to determine the length of time for which the user input component is activated and to send a control signal to the tuner based on that determination.

The tuner may be configured to operate in one of the three tuning modes in response to receiving the control signal from the tuning mode selector (e.g., a tuning mode selection means).

The radio may comprise a memory configured to store a set of one or more carrier frequencies and the tuning mode selector may be configured to, when the tuning mode selector determines that the tuner is to operate in the first tuning mode, send a control signal identifying a stored carrier frequency to the tuner.

When the tuner operates in the first tuning mode, the tuner may be configured to select a signal component of the carrier frequency identified in the control signal from the plurality of received signal components.

When the tuner operates in the second tuning mode, the tuner may be configured to repeatedly select signal components of increasing carrier frequency until a selected signal component is received having a signal quality greater than a predetermined quality threshold.

When the tuner operates in the third tuning mode, the tuner may be configured to repeatedly select signal components of increasing carrier frequency while the user input component is activated and, when the user input component is deactivated, to continue selecting the signal component that was selected when the user input component was deactivated.

The first period of time may be one second and the second period of time may be two seconds.

In an embodiment, the user input component is a selector that is activated when pressed by a user and is deactivated when released by the user.

### BRIEF DESCRIPTION OF THE DRAWINGS

For a better understanding of the present disclosure, reference is made to the following drawings in which:

FIG. 1 shows an radio in accordance with the present disclosure;

FIG. 2 shows a flow diagram illustrating the method of operating a radio according to the present disclosure.

### DETAILED DESCRIPTION

According to one embodiment of the present disclosure, a single selector can be used to select between different tuning functions of a radio. The different tuning functions might be, for example, manual searching through the frequency range, automatic searching through the frequency range and a stepping function to switch between predefined frequencies. These functions are given for the purposes of example only and embodiments of the present disclosure could enable a user to select between any suitable functions of a device. For example, the disclosure could enable a user to select between the different operational modes of an audio device, such as cassette player, CD player, and radio, to name a few.

According to embodiments of the present disclosure, a user is able to select between different tuning functions of a radio by pressing a single selector for an appropriate length of time. The selector may be of a type that can be pressed and held down and which will spring back upon release. Therefore, the radio may be able to determine how long the selector has been pressed for and thus which tuning function has been selected by the user. Although the implementation of the present disclosure will be primarily described in relation to a selector, it should be understood that the disclosure could be implemented using any suitable means for allowing a user to control a device e.g., touchpads, switches, keys, and a remote control, to name a few.

A radio for implementing the present disclosure may provide the user with a number of different tuning functions or modes. For example, the user should be able to manually tune the radio to a particular frequency. The radio should also have an automatic frequency search function in which the radio automatically scans through the available frequency range and stops the searching process when a signal is received having a quality higher than a predetermined threshold. The threshold is typically chosen to correspond to a reception quality that radio listeners generally find acceptable.

An automatic search typically commences at the current frequency and scans upwards through the remaining frequency range, before starting to scan upwards from the bottom of the range when the top of the range is reached. For example, for frequency modulated (FM) signals the available frequency range extends from 87.5 MHz to 108 MHz. If the user is listening to channel 3 in table 1 and selects the automatic frequency search function, the radio will search through frequencies 99.7 MHz to 108 MHz and then from 87.5 MHz upwards. If the radio receives a signal of sufficient quality, it stops searching and plays that signal through the loudspeaker. The user may re-select the automatic frequency search mode by pressing the tuning selector for the required length of time and the searching procedure will start from the current frequency. The frequency to which the radio is tuned is displayed on a display. Similarly, as the radio scans through the available frequency range the frequencies through which the radio is searching are also displayed.

The radio should also enable a user to designate particular radio stations. For example, table 1 lists radio stations that a user resident in London might designate.

TABLE 1

| Channel number | Radio station | Designated frequency |
|---|---|---|
| 1 | Radio 2 | 88.1 MHz |
| 2 | Capital FM | 95.8 MHz |
| 3 | Radio 1 | 99.7 MHz |
| 4 | Classic FM | 100.9 MHz |

The radio might provide the user with any number of channels for designating particular frequencies that they listen to often. The radio might have a designated selector for each channel. For example, a radio that enables the user to designate four radio stations might have four selectors, one for each channel. However, a radio for implementing the present disclosure may provide the user with a “stepping” tuning function whereby the user can “step” through the different channels by pressing a single selector. The radio might be configured to step through the channels in channel number order or alternatively in frequency order. Typically, the stepping function will start “stepping” from the channel that the radio is currently tuned to. For example, if the user has designated the channels according to table 1 and the radio is tuned to channel 2, pressing the tuning selector for the appropriate length of time to trigger the stepping function will cause the radio to tune to channel 3. Pressing the selector for the appropriate length of time for a second time would cause the radio to tune to channel 4. If the radio is not tuned to one of the designated frequencies, the stepping function may “step” to channel 1. Alternatively, the radio might step to the channel having the closest designated frequency to the current frequency.

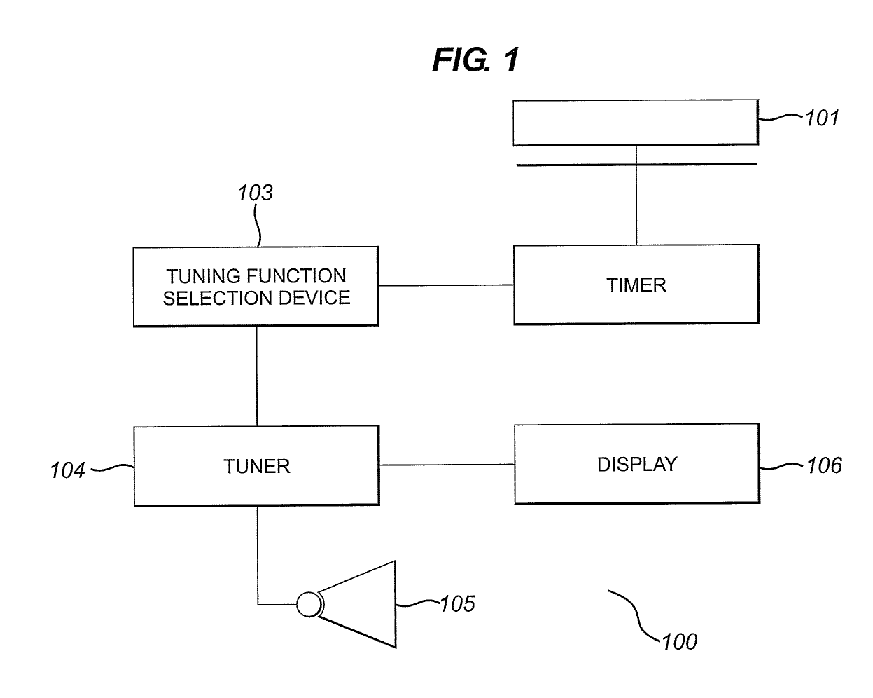

An example of a suitable radio, shown generally at 100, is illustrated in FIG. 1. The radio comprises the conventional components common to all radios such as a tuner 104, a display 106 and a loudspeaker 105. The device further comprises a selector 101, a timer 102 and a tuning function selection device 103. The selector 101 may be a push button, such as that described above, which is linked to a timer 102. The timer 102 is started when the selector 101 is pressed and stopped when the selector 101 is released. The tuning function selection device 103 monitors the timer 102. The device 103 then selects the appropriate frequency search function in accordance with the length of time for which selector 101 is pressed, or in accordance with the length of time that has elapsed since the selector 101 was first pressed if the selector 101 is not released. The device 103 then sends an appropriate signal to the tuner 104, thus causing the radio to tune to a particular frequency or to search through the available frequency range in accordance with a particular tuning function. The audio signal recovered by the tuner 104 from the range of received signals is passed to the loudspeaker 105. Similarly, the display 106 displays the carrier frequency of the received signal which is currently being fed to the loudspeaker 105.

The tuning function selection device 103 comprises a memory, or is coupled to a memory, that stores a database of designated frequencies, such as those listed in table 1, for example. When the user selects the stepping function, the tuning selection device 103 determines what frequency the tuner should select and includes a signal identifying that frequency in the signal sent to the tuner.

FIG. 1 is a simple diagram that shows the relevant functional components of the radio as discrete functional blocks. This is for the purposes of example only and it should be understood that the various functions could be implemented separately or in combination. Similarly, it should be understood that further components are contained in actual radios (e.g., circuitry for demodulating the received signal) and that these have been omitted from FIG. 1 for reasons of simplicity. The present disclosure is not limited to any specific design of radio, but is applicable to any radio that provides a tuning function to a user.

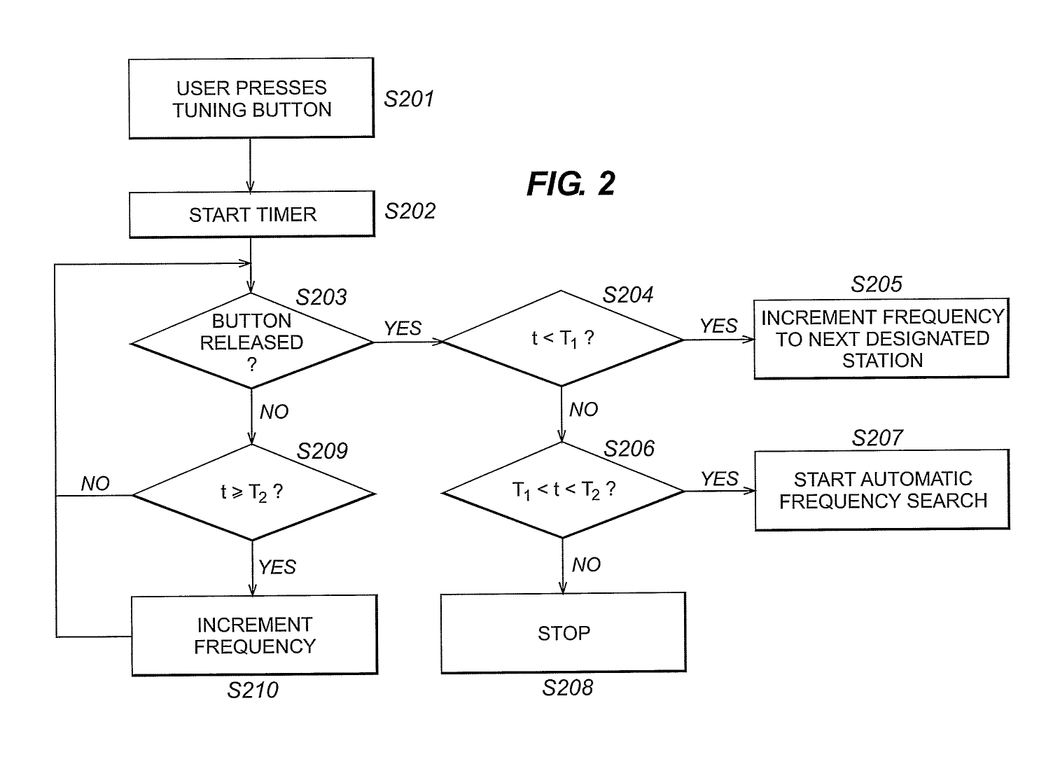

FIG. 2 illustrates a method of operating a radio according to the present disclosure. In step S201, the user presses the selector that is designated for selecting a tuning function. In step S202, a timer is started to monitor the length of time for which the selector is pressed. In step S203, the radio determines whether the user has released the tuning selector. If yes, the method proceeds to step S204, in which it is determined whether the time t for which the selector was pressed is less than T1 seconds. If yes, the method proceeds to step S205, in which the radio operates according to a first tuning function. In FIG. 2, this first tuning function is a “stepping” function in which radio is tuned to the frequency of the next designated station.

If the condition in step S204 is not true, the method proceeds to step S206. In step S206 it is determined whether the selector was pressed for a time greater than T1 seconds but less than T2 seconds. If yes, the method proceeds to step S207 and the radio operates its second tuning function. In this case, the second tuning function is an automatic frequency search function.

If the answer to the query in step S206 is no, then the method proceeds to step S208 in which the radio does not operate any of the three tuning functions, but instead remains tuned to the current frequency.

If in step S203 the selector is not released, then the method proceeds to step S209. In step 209 it is determined whether or not the selector has been pressed for T2 seconds or longer. If yes, the radio operates in the third tuning function in step S210. In this case, the third tuning mode is the manual frequency search function, so that the radio increments the frequency until the selector is released by the user. The incrementing frequency is displayed on a display 106, in the same way as when the frequency is incremented automatically. Once the selector is released, the method proceeds through steps S204 and S206 to step S208, in which the radio does not operate any of the three tuning functions (i.e., when the user releases the selector in the manual frequency search function, the radio remains tuned to the current frequency).

Although most users would probably find it more intuitive for the channel or frequency to be incremented when the selector is pressed, the single selector might equally decrement the channel or frequency instead. Additionally, although only a single selector is actually required to access all the available channels and frequencies, it may be preferable to include two selectors: one that increments and the other that decrements the selected frequency. Having two selectors may speed up the process of searching for a particular channel or frequency.

The intervals T1 and T2 may be chosen to be appropriate to human response times, so they are neither too short to be manageable nor too long to be irritating. Also, the difference between T1 and T2 must be sufficient for the user to be able to accurately select in which of the tuning modes he or she wants the radio to function. Suitable values for T1 and T2 might be, for example, 1 second and 2 seconds respectively.

The tuning modes need not be accessed in the order shown in the method of FIG. 2. However, the selection of a manual frequency search will usually require the tuning selector to be pressed for the longest period of any of the modes, as the manual search the search is stopped when the user releases the selector.

A radio according to the present disclosure may provide more or fewer than three different tuning functions or other suitable functions. The user may select between any number of different functions by using a single selector and the method described above.

The present disclosure provides an improved arrangement for allowing the user to select between the different tuning functions of a radio. In particular, it enables a single selector or other suitable user selection device to be used to select between multiple different tuning functions. This is especially beneficial for small devices where space is limited and also for applications such as car radios, where a single multi-functional selector advantageously simplifies the user interface and thus minimizes the amount of attention that is diverted from the road.

Each individual feature described herein may be used in isolation or in any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. Aspects of the present disclosure may include any such feature or combination of features. In view of the foregoing description it will be evident to a person skilled in the art that various modifications may be made within the scope of the disclosure.

1-12. (canceled)

13. A radio, comprising:
a receiver configured to receive signals, wherein the signals comprise a plurality of signal components of different carrier frequencies;
a tuner configured to select a signal component of a particular carrier frequency from the plurality of received signal components; and
a user interface comprising a user input component, wherein:
when the user input component is activated for less than a first period of time, the tuner operates in a first tuning mode;
when the user input component is activated for longer than the first period of time and less than a second period of time, the tuner operates in a second tuning mode;
when the user input component is activated for at least the second period of time, the tuner operates in a third tuning mode; and
each of the first, second, and third tuning modes is configured to cause the tuner to select a signal component of a particular carrier frequency.

14. The radio of claim 13, further comprising a tuning mode selector configured to determine the length of time for which the user input component is activated and to send a control signal to the tuner based on that determination.

15. The radio of claim 14, wherein the tuner is configured to operate in one of the three tuning modes in response to receiving the control signal from the tuning mode selector.

16. The radio of claim 14, further comprising a memory configured to store a set of one or more carrier frequencies.

17. The radio of claim 16, wherein the tuning mode selector is configured to, when the tuning mode selector determines that the tuner is to operate in the first tuning mode, send a control signal identifying a stored carrier frequency to the tuner.

18. The radio of claim 17, wherein the tuner is configured to, when the tuner operates in the first tuning mode, select a signal component of the carrier frequency identified in the control signal from the plurality of received signal components.

19. The radio of claim 18, wherein the tuner is configured to, when the tuner operates in the second tuning mode, repeatedly select signal components of increasing carrier frequency until a selected signal component is received having a signal quality greater than a predetermined quality threshold.

20. The radio of claim 19, wherein the tuner is configured to, when the tuner operates in the third tuning mode, repeatedly select signal components of increasing carrier frequency while the user input component is activated and, when the user input component is deactivated, to continue selecting the signal component that was selected when the user input component was deactivated.

21. The radio of claim 13, wherein the first period of time is one second.

22. The radio of claim 13, wherein the second period of time is two seconds.

23. The radio of claim 13, wherein the user input component is a selector configured to be activated when pressed by a user and deactivated when released by the user.

24. A method, comprising:
receiving signals at a receiver of a radio, wherein the signals comprise a plurality of signal components of different carrier frequencies;
operating the radio in a first tuning mode when a user input component is activated for less than a first period of time;
operating the radio in a second tuning mode when the user input component is activated for longer than the first period of time and less than a second period of time; and
operating the radio in a third tuning mode when the user input component is activated for at least the second period of time;
wherein each of the first, second, and third tuning modes is configured to cause a tuner of the radio to select a signal component of a particular carrier frequency.

25. The method of claim 24, wherein the operating the radio in a first tuning mode step comprises one of:
selecting a signal component of the carrier frequency identified in the control signal from the plurality of received signal components;
repeatedly selecting signal components of increasing carrier frequency until a selected signal component is received having a signal quality greater than a predetermined quality threshold; or
repeatedly selecting signal components of increasing carrier frequency while the user input component is activated and, when the user input component is deactivated, to continue selecting the signal component that was selected when the user input component was deactivated.

26. The method of claim 24, wherein the operating the radio in a second tuning mode step comprises one of:
selecting a signal component of the carrier frequency identified in the control signal from the plurality of received signal components;
repeatedly selecting signal components of increasing carrier frequency until a selected signal component is received having a signal quality greater than a predetermined quality threshold; or
repeatedly selecting signal components of increasing carrier frequency while the user input component is activated and, when the user input component is deactivated, to continue selecting the signal component that was selected when the user input component was deactivated.

27. The method of claim 24, wherein the operating the radio in a third tuning mode step comprises one of:
selecting a signal component of the carrier frequency identified in the control signal from the plurality of received signal components;
repeatedly selecting signal components of increasing carrier frequency until a selected signal component is received having a signal quality greater than a predetermined quality threshold; or
repeatedly selecting signal components of increasing carrier frequency while the user input component is activated and, when the user input component is deactivated, to continue selecting the signal component that was selected when the user input component was deactivated.

28. The method of claim 24, wherein the operating the radio in a first tuning mode step comprises selecting a signal component of the carrier frequency identified in the control signal from the plurality of received signal components;
wherein the operating the radio in a second tuning mode step comprises repeatedly selecting signal components of increasing carrier frequency until a selected signal component is received having a signal quality greater than a predetermined quality threshold; and
wherein the operating the radio in a third tuning mode step comprises repeatedly selecting signal components of increasing carrier frequency while the user input component is activated and, when the user input component is deactivated, to continue selecting the signal component that was selected when the user input component was deactivated.

29. A radio, comprising:
a receiving means configured to receive signals, wherein the signals comprise a plurality of signal components of different carrier frequencies;
a tuning means configured to select a signal component of a particular carrier frequency from the plurality of received signal components; and
a user input component configured to cause the tuner to operate:
in a first tuning mode when the user input component is activated for less than a first period of time;
operate in a second tuning mode when the user input component is activated for longer than the first period of time and less than a second period of time; and
operate in a third tuning mode when the user input component is activated for at least the second period of time; and
wherein each of the first, second, and third tuning modes is configured to cause the tuning means to select a signal component of a particular carrier frequency.

30. The radio of claim 29, further comprising a tuning mode selection means configured to determine the length of time for which the user input component is activated and to send a control signal to the tuning means based on that determination.

31. The radio of claim 30, wherein the tuning mode selection means is configured to, when the tuning mode selection means determines that the tuning means is to operate in the first tuning mode, send a control signal identifying a stored carrier frequency to the tuning means.

32. The radio of claim 31, wherein the tuning means is configured to:
when the tuning means operates in the first tuning mode, select a signal component of the carrier frequency identified in the control signal from the plurality of received signal components;
when the tuning means operates in the second tuning mode, repeatedly select signal components of increasing carrier frequency until a selected signal component is received having a signal quality greater than a predetermined quality threshold; and
when the tuning means operates in the third tuning mode, repeatedly select signal components of increasing carrier frequency while the user input component is activated and, when the user input component is deactivated, to continue selecting the signal component that was selected when the user input component was deactivated.
